(19) United States
(12) Patent Application Publication
(10) Pub. No.: US 2015/0111978 A1
(43) Pub. Date: Apr. 23, 2015

(54) METHOD OF FORMING DUAL CURABLE POLYMER COMPOSITIONS

(71) Applicant: NIPSEA Technologies Pte Ltd., Singapore (SG)

(72) Inventors: Shaofeng Wang, Singapore (SG); Zeling Dou, Singapore (SG); Swee How Seow, Singapore (SG)

(21) Appl. No.: 14/398,381

(22) PCT Filed: Aug. 22, 2013
(86) PCT No.: PCT/SG2013/000364

§ 371 Date: Oct. 31, 2014

(30) Foreign Application Priority Data
Aug. 23, 2012 (GB) 1215049.6

(51) Int. Cl. C08G 18/10; C08G 18/81; C09D 175/04

(52) U.S. Cl. CPC C08G 18/10; C09D 175/04; C08G 18/8125
USPC 522/8; 525/454

(57) ABSTRACT

The present disclosure provides a method of preparing a dual curable polymer, the method comprising the steps of: (a) reacting a peripheral reactive group of a dendritic polymer with a cross-linker compound having two or more moisture curable functional groups to form a functionalized dendritic polymer terminated with the moisture curable functional groups; and (b) reacting said functionalized dendritic polymer with an acrylic compound to form a substituted dendritic polymer having a mixture of acrylate functional groups and at least one peripheral moisture curable functional group.

### TECHNICAL FIELD

This invention relates to a method for forming a dual curable polymer and compositions prepared from the same.

### BACKGROUND

Polyurethane dispersions (PUD) have been the subject of much study due to their applicability in protective coatings and adhesives for a number of industries, such as the automotive and marine industry. In particular, polyurethane dispersions comprising dendritic polymers, have gained attention due to their unique monodisperse core structures and their ability to form coatings with improved mechanical properties and chemical resistance.

Ever stricter environmental regulations in numerous countries have resulted in a push towards the use of radiation curable PUD which presents little or no TOC (“Volatile Organic Compounds”) emission. Other advantages of radiation curing include rapid cure duration and low energy requirements. Accordingly, waterborne radiation curable polymer compositions and methods for preparing these compositions have been discussed in the state of the art.

In one known method for preparing such coatings, a hydroxyl functional dendritic polymer is first surface modified via reaction with fatty acids to introduce hydrophobic moieties on the peripheral surface of the dendritic polymer. An intermediate adduct reactant is then prepared by reacting polyethylene glycol (PEG) with an anhydride. The intermediate adduct compound is then reacted with the hydroxyl functional dendritic polymer to form an amphiphilic dendritic polymer having hydrophilic PEG groups and hydrophobic fatty acid ester chains. The amphiphilic polymer is then reacted with an acrylic oligomer to form a waterborne, UV curable polymer composition.

However, a UV curable polymer composition prepared from the above method is limited by the typical drawbacks of a UV curable composition. For instance, the curing process requires the irradiation by UV radiation and only the irradiated portions experience curing. Consequently, such polymer compositions cannot cure in the shade or may experience partial curing where the irradiation is not provided uniformly.

Another known method for preparing a waterborne radiation curable dendritic polymer comprises reacting a dendritic polymer with an anhydride to introduce peripheral carboxyl groups on the dendritic polymer. An intermediate compound is then prepared via the reaction of a diisocyanate with hydroxyethyl acrylate (“HEA”). Thereafter, the carboxyl-modified dendritic polymer is reacted with the intermediate compound to form a product dendritic polymer having both —COOH functionality and acrylate functionality. Optionally, an amine may be added to the dendritic polymer to ionize the —COOH group into salt form to increase water solubility.

Similarly, polymer compositions prepared through the above method also suffers the drawback of not being able to cure in the absence of a radiation source and may also experience partial curing where the radiation source is weak or is not uniformly applied to the composition.

Accordingly, there is a need to provide a method for preparing a radiation curable polymer composition that overcomes or at least ameliorates the technical disadvantages discussed above.

### SUMMARY

In a first aspect, there is provided a method of preparing a dual curable polymer, the method comprising the steps of: (a) reacting a peripheral reactive group of a dendritic polymer with a cross-linker compound having two or more moisture curable functional groups to form a functionalized dendritic polymer terminated with said moisture curable functional groups; and (b) reacting said functionalized dendritic polymer with an acrylate compound to form a substituted dendritic polymer having a mixture of acrylate functional groups and at least one-peripheral moisture curable functional group.

Advantageously, the disclosed method is capable of synthesizing dual curable (moisture and UV-curable) polymer compositions comprising globular, monodisperse dendritic core structures functionalized with at least one type of UV curable functional group, e.g., acrylate and at least one type of a moisture curable functional group, e.g., isocyanate. Advantageously, the presence of at least these two types of functional groups leads to the formation of a “dual-curable” dendritic polymer composition, i.e., a dendritic polymer composition that is both moisture curable and/or radiation curable.

Advantageously, a dual-cure dendritic polymer composition prepared according to the above method will comprise all the technical benefits of UV curing, including but not limited to,
fast curing (in seconds);
high yield/productivity of such coatings due to ease and speed of curing;
small curing units;
low energy requirement; and
can be formulated as one pot (“1K”) compositions (no pot-life concerns as opposed to two-pot(2K) systems where the composition has to be used quickly after mixing).

Advantageously, the dual-cure dendritic polymer composition may further exhibit improved mechanical properties (e.g. high surface hardness) and chemical resistance (e.g., alkaline resistance, alcohol resistance).

Still advantageously, the dual-cure dendritic polymer composition prepared via the above method also overcomes the limitations of UV curing. Specifically, the moisture curable groups can react with naturally occurring moisture in the environment or optionally other additive reactants (e.g., a polyol) to cause curing at room temperature, even in the absence of a radiation source. Additionally, the disclosed dual curable polymer is especially useful for forming a cured coating on three-dimensional substrates, because 3D substrates typically experience non-uniform UV curing due to the asymmetrical exposure to UV radiation caused by its 3D conformation. Having a dual-curable coating overcomes this problem.

Accordingly, the disclosed method is flexible, in the sense that the dendritic polymer composition can be cured in the shade or under irradiation by a UV source or both. Additionally, the disclosed method provides flexibility in that the cross-linker compound can be selectively chosen to confer either hydrophilicity or hydrophobicity onto the dendritic polymer composition. Accordingly, the disclosed method may be employed to prepare either a waterborne dual cure dendritic composition or a solvent-based dual cure dendritic polymer.

In a second aspect, there is provided a dendritic polymer having a mixture of peripheral functional groups selected from UV curable functional groups and moisture curable functional groups, wherein said dendritic polymer comprises a total of at least a total of 8 to 128 functional groups per polymer molecule. The moisture curable functional groups may comprise at least one peripheral moisture curable functional group.

In another aspect, there is provided a polymer composition comprising (a) a dual curable dendritic polymer according as prepared or described above; (b) a catalyst; and (c) a photoinitiator. This polymer composition may be provided as a one-pot system.

In yet another aspect, there is provided a two-component, dual curable composition, comprising a Side A and a Side B, said Side A comprising: (a) a dual curable dendritic polymer as prepared or described above; (b) curing catalyst; (c) a photo-initiator; and wherein Side B comprises: (d) cross-linkers.

In another aspect, there is provided a substituted dendritic polymer prepared according to the method of the first aspect. In another aspect, there is provided a substrate that has been coated with the above defined dual curable dendritic polymer.

### DEFINITIONS

The following words and terms used herein shall have the meaning indicated:

The term “radiation curable polymer” or “radiation cure polymer”, as used in the context of the present specification, shall be taken to refer to a polymer comprising functional groups capable of forming covalent bonds with chain extenders, cross-linkers, other polymer molecules upon exposure to electromagnetic radiation, including ultra-violet (UV) radiation, to form a cross-linked polymer network. The term “radiation curable” shall be construed accordingly.

The term “moisture curable polymer” or “moisture cure polymer” as used in the context of the present specification shall be taken to refer to a polymer having functional groups capable of forming covalent bonds with identical or different functional groups upon reaction with water, to form a cross-linked polymer network. The term “moisture curable” shall be construed accordingly.

The term “dual cure” or “dual curable” as used in the context of the present specification shall refer to a polymer comprising UV curable and moisture curable functionality.

As used herein, the term “dendritic polymer” refers to a three-dimensional macromolecular material comprising a polyvalent core that is covalently bonded to a plurality of dendrons (or tree-like structures). The term “dendron” means a tree-like structure having multiple branching layers (or “generations”) that emanates from a focal point, such as a polyvalent core. Each succeeding branching layer or generation of a dendron extends from the prior generation, and each branching layer or generation in the dendron has one or more terminal reactive sites (or “terminal functional groups”) from which the succeeding generation (if any) may extend, or in the case of the last generation, which may provide a terminal functional group on the dendritic polymer. Dendritic polymers generally have a large number of terminal functional groups, lack entanglements, and have a low hydrodynamic volume. Further, as used herein, the term “dendritic polymer” includes both “dendrimers” and “hyperbranched polymers”. In certain embodiments, the term “dendritic polymer” includes solely hyperbranched polymers. As used herein, the term “dendrimer” refers to a dendritic polymer having a symmetrical globular shape that results from a controlled process giving an essentially monodisperse molecular weight distribution.

As used herein, the term “hyperbranched polymer” refers to a dendritic polymer having a certain degree of asymmetry and a polydisperse molecular weight distribution. In certain instances, the hyperbranched polymer has a globular shape. Hyperbranched polymers may be exemplified by those marketed by Perstorp under the Trademarks Boltorn H20™, Boltorn H30™, Boltorn H40™, etc.

The, word “substantially” does not exclude “completely” e.g. a composition which is “substantially free” from Y may be completely free from Y. In some instances, where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−30 of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6. etc., as well as individual numbers within that range, for example, 1, 2, 3, 4, 5, and 6. This applies regardless of the breadth of the range.

### DISCLOSURE OF OPTIONAL EMBODIMENTS

Exemplary, non-limiting embodiments of a method for preparing a dual curable dendritic polymer will now be disclosed.

In one embodiment, there is provided a method of preparing a dual curable polymer, the method comprising the steps of: (a) reacting a peripheral reactive group of a′dendritic polymer with a cross-linker compound having two or more moisture curable functional groups to form a functionalized dendritic polymer terminated with said moisture curable functional groups; and (b) reacting said functionalized dendritic polymer with an acrylate compound to form a substituted dendritic polymer having a mixture of acrylate functional groups and at least one peripheral moisture curable functional group.

The dendritic polymer may comprise reactive groups selected from the group consisting of: hydroxyl (—OH), amine (—NH₂), carboxyl (—COOH), carbamate and halogen. In one embodiment, the dendritic polymer consists of hydroxyl reactive groups disposed about the periphery of the dendritic polymer. In some embodiments, the dendritic polymer is hydroxyl functional hyperbranched polyester. Non-limiting examples of hydroxyl functional hyperbranched polyesters include hyperbranched polymers marketed under the Boltorn trademark sold by Perstorp specialty Chemicals, such as Boltorn H20, Boltorn H30, and Boltorn H40. These materials generally have a weight average molecular weight in the range of 1,000 amu and 4,000 amu. Boltron H20, H40, and H30 have on average 16, 32, and 64 terminal hydroxyl groups respectively.

The cross-linker compound may be selected to comprise moisture curable functional groups capable of forming covalent bonds with said acrylate compound and the reactive groups disposed on the dendritic polymer. Exemplary moisture curable functional groups may be selected from, but are not limited to, the group consisting of: isocyanates, blocked isocyanates, mono-oxazolidines, and bis-oxazolidines. It will be appreciated that the selection of the cross-linker compound may be dependent on the type of reactive group possessed by the dendritic polymer. Once the moisture curable functional group forms a covalent bond with the reactive group disposed on the dendritic polymer, further reaction may not occur at the reacted functional group.

Thus, the reacted functional group may not confer moisture curable functionality to the dendritic polymer. On the other hand, peripheral, unreacted functional groups may be available for further reaction and thus may confer moisture curable functionality to the functionalized dendritic polymer. Therefore advantageously, the dual curable polymer has at least one peripheral moisture curable functional group to thereby confer moisture curable functionality to the polymer.

Exemplary combinations of reactive groups and cross-linkers are provided hereafter for illustration without limitation. For instance, dendritic polymers having hydroxyl functionality may readily react with isocyanate and anhydride cross-linkers, whereas dendritic polymers having amine or carboxyl functionality may readily react with epoxy cross-linkers, carboiimide cross-linkers and aziridine cross-linkers.

In one embodiment, the cross-linker compound may be a polyisocyanate. The polyisocyanates may be selected from the group of diisocyanates, tri-isocyanates, and dimers, biuret dimers, and isocyanurate trimers of the aforementioned polyisocyanates, and mixtures thereof.

Polyisocyanates can exist in different oligomeric forms, such as dimers, biuret dimers, and isocyanurates. These polyisocyanates can be represented by the structures shown below, wherein R¹ is as defined above.

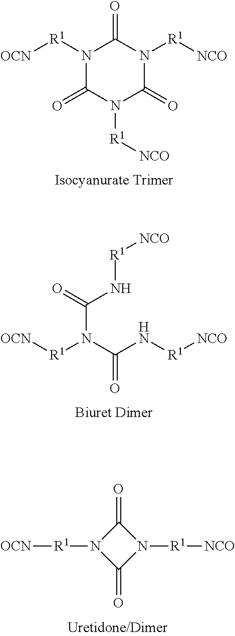

In one embodiment, HDI isocyanurate is used to functionalize the dendritic polymer to at least double the number of isocyanate functional groups at the peripheral surface of the dendritic polymer. More than one-type of polyisocyanate may be used in combination.

The polyisocyanate may be of the general formula R¹(NCO)ₙ, wherein R¹ is alkyl, alkenyl, alkynyl, cycloalky, heterocyclocalkyl, aryl, diaryl, dicycloalkyl, 5-6 membered heterocyclic compound optionally substituted with one or more of a halogen, oxygen, nitrogen, or C₂-C₁₀ alkyl; and n is a whole number selected from 2-30; selected from 2-10, selected from 2-10; or selected from 3-7.

In one embodiment, R¹ is selected from the group consisting of: C₁-C₁₀ alkyl, C₁-C₁₀ alkenyl, alkynyl, C₃-C₇ cycloalkyl, C₃-C₇ heterocycloalkyl, C₆-C₁₂ dicycloalkyl, C₆-C₁₄ aryl, C₆-C₁₄ heteroaryl, triazines, and isocyanurate, each optionally substituted by C₁-C₁₀ alkyl, halogen, or oxygen. In one embodiment, R¹ may be selected from the group consisting of: phenyl, diphenyl, methylene diphenyl, cyclohexyl, dicyclohexyl, methylene dicyclohexyl, xylene, toluene, and substituted triazinane.

In specific embodiments, the polyisocyanate is selected from the group consisting of: toluene diisocyanate (TDI), methylene diphenyl diisocyanate (MDI), 4′4-dicyclohexamethylene diisocyanate (H₁₂MDI), xylene diisocyanate, p-phenyl diisocyanate (PPDI), hexamethylene diisocyanate (HDI), isophorone diisocyanate (IPDI), trimethyl hexamethylene diisocyanate (TMDI), and dimers, biuret dimers, and isocyanurate trimers of the aforementioned polyisocyanates, and/or mixtures thereof. In one embodiment, the polyisocyanate is a mixture comprising isocyanurate trimers of HDI and dimers of HDI.

In one embodiment, prior to reaction with the dendritic polymer, the polyisocyanates may be modified to exhibit hydrophilicity. In one embodiment, the polyisocyanates may be ether-modified, polyether-modified or conically modified to thereby exhibit hydrophilicity. Exemplary hydrophilic polyisocyanates may include those marketed by Bayer Material Science AG, under the Trademark Bayhydur® XP2547, Bayhydur® XP2655, Bayhydur® XP2759, Bayhydur® XP2487, Desmodur® N3300, Desmodur® N3390, Desmodur® N3400, Desmodur® N3600, etc.

The amount of cross-linker compound reacted may be suitably adjusted in order to achieve a substantially functionalized dendritic polymer terminated with the moisture curable functional groups. The cross-linker compound may be reacted in stoichiometric excess with the peripheral reactive group of the dendritic polymer. Advantageously, the reaction of a stoichiometric excess of cross-linker compound ensures that each peripheral reactive group of the dendritic polymer may be substantially completely reacted with a cross-linker compound.

In an embodiment, a moisture curable functional group of the cross-linker compound is reacted in stoichiometric excess with a peripheral reactive group of the dendritic polymer, for example in a stoichiometric ratio of about 1.5:1, or about 2:1, or about 3:1 or higher. In another embodiment, a moisture curable functional group of the cross-linker compound is reacted in a stoichiometric ratio with a peripheral reactive group of the dendritic polymer of about 1:1.

The dendritic polymer may be selected from a dendritic polymer having a theoretical number of peripheral reactive groups of from 16 to 128 peripheral reactive groups per dendritic polymer molecule. The theoretical number of peripheral reactive groups depends on the “generation” of the dendritic polymer. Typically, a second-generation dendritic polymer is expected to have peripheral groups, a third generation 32, a fourth generation 64, and so forth. In one embodiment, the dendritic polymer is selected to be a fourth-generation dendritic polymer, having about 64 peripheral hydroxyl groups per dendritic polymer molecule. Advantageously, a higher generation dendritic polymer provides a higher density of hydroxyl groups for reaction and cross-linkage. However, having too high a density of cross-linkable functional groups can also result in the formation of excessively viscous polymer compositions which may not be readily dispersed in either an aqueous or organic solvent. This would adversely affect its applicability as a coating composition.

In one embodiment, the reaction between a polyisocyanate and a hydroxyl terminated dendritic polymer may be exemplified by Scheme I as shown below.

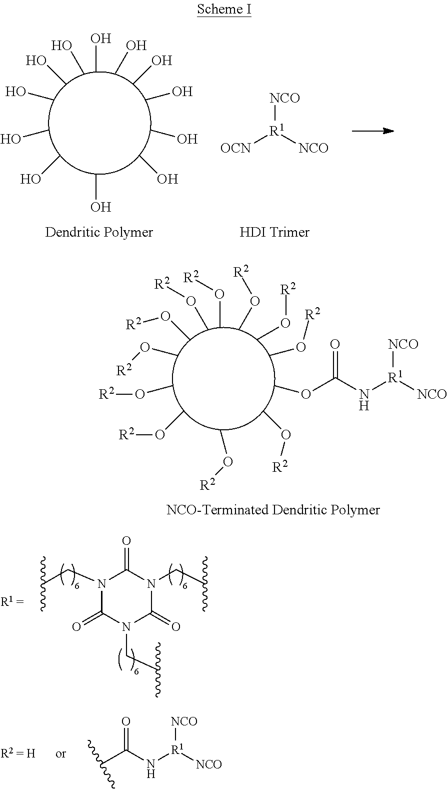

As can be seen from Scheme I, the HDI trimer has three isocyanate groups available for reaction. The isocyanate functional group is —N═C═O. The HDI trimer may be reacted in stoichiometric excess to each peripheral hydroxyl functional group on the dendritic polymer. The isocyanate functional group forms at least one carbamate bond with a hydroxyl functional group on the dendritic polymer, resulting in a replacement functional group terminated by two isocyanate groups. In instances where the HDI trimer is reacted in excess, each R² may result in a replacement functional group terminated by two isocyanate groups. In this instance, R² may not be H.

Once the isocyanate functional group forms a carbamate bond, no further reaction can occur at the reacted functional group. Thus, the reacted functional group may not confer moisture curable functionality to the dendritic polymer. On the other hand, the two peripheral, unreacted isocyanate groups are available for further reaction and thus confer moisture curable functionality to the functionalized dendritic polymer.

Advantageously, as can be seen from the above reaction scheme, the use of polyisocyanates having at least three isocyanate groups would effectively double the total peripheral functionality of the dendritic polymer. For instance, if a 4^{th}-generation dendritic polymer, having 64 peripheral hydroxyl groups, is reacted with 64 equivalents of HDI trimer, the reaction product would have a theoretical total number of 128 isocyanate groups on the periphery of the dendritic polymer.

In one embodiment, the acrylate compound may comprise at least one moiety capable of reacting with said moisture curable functional group. The moiety may be selected from the group consisting of: —OH, and —NHR, wherein R is hydrogen, alkyl, alkenyl, alkynyl, araalkyl, cycloalkyl, heterocycloalkyl, aryl, or heteroaryl. In one embodiment, the acrylate compound is a hydroxyl terminated acrylate (i.e., contains at least one terminal —OH moiety). Advantageously, the terminal moiety of the acrylate compound may be suitably selected to form covalent bonds with the terminal moisture-curable functional groups disposed on the functionalized dendritic to thereby graft acrylate functionality onto the dendritic polymer.

In one embodiment, the acrylate compound comprises a hydroxyl reactive functional group, wherein the hydroxyl reactive functional group is capable of reacting with at least one hydroxyl group of the dendritic polymer to form a covalent bond. The hydroxyl reactive functional group can include, but is not limited to isocyanate, anhydride, carboxylic acid, and carboxyl chloride. Reaction of a suitably modified acrylate compound with a hydroxyl group of the dendritic polymer allows for direct attachment of the UV curable group to the dendritic polymer.

The amount of acrylate compound reacted with the functionalized dendritic polymer may be suitably adjusted in order to form a substituted dendritic polymer having a mixture of acrylate functional groups and moisture curable functional groups. The amount of the acrylate compound relative to the cross-linker compound may be controlled in order to form the dual curable polymer. In embodiments, the stoichiometric amount of the acrylate compound is controlled to be less than the stoichiometric amount of the cross-linker compound. In an embodiment, the stoichiometric ratio of the acrylate compound to the cross-linker compound is less than 1.

Advantageously, as there is a lesser amount of the acrylate compound as compared to the cross-linker compound, some of the peripheral moisture curable functional groups of the cross-linker compound may not be reacted with the acrylate compound. A substituted dendritic polymer having at least one peripheral moisture curable functional group may advantageously be obtained.

In instances, the stoichiometric ratio of said acrylate compound to said cross-linker compound is from about 0.01:1 to about 0.99:1. In embodiments, the stoichiometric ratio of said acrylate compound to said cross-linker compound is from about 0.01:1 to about 0.99:1, or from about 0.05:1 to about 0.99:1, or from about 0.05:1 to about 0.9:1.

The molar concentrations of the dendritic polymer and acrylate compound may be suitably adjusted in order to achieve a desired UV-curable to moisture-curable functionality ratio. In one embodiment, the stoichiometric amount of reactants may be selected in order to yield a substituted dendritic polymer having a ratio of moisture curable functional groups to UV curable functional groups from about 1:0.9 to about 1:0.05, about 1:0.9 to about 1:0.1, about 1:0.7 to about 1:0.05, about 1:0.5 to about 1:0.05, about 1:0.3 to about 1:0.05, about 1:0.2 to about 1:0.05, or about 1:0.1 to about 1:0.05. In certain embodiments, the stoichiometric amount of reactants may be selected in order to yield a substituted dendritic polymer having a ratio of UV curable functional groups to moisture curable functional groups from about 1:0.9 to about 1:0.05, about 1:0.9 to about 1:0.1, about 1:0.7 to about 1:0.05, about 1:0.5 to about 1:0.05, about 1:0.3 to about 1:0.05, about 1:0.2 to about 1:0.05, or about 1:0.1 to about 1:0.05. In other embodiments, the ratio of moisture curable functionality to UV cure functionality may be selected from the group consisting of: 1:0.9, 1:0.8, 1:0.7, 1:0.6, 1:0.5, 1:0.4, 1:0.3, 1:0.2 and 1:0.1. In another embodiment, the stoichiometric amount of reactants may be selected in order to yield a substituted dendritic polymer having a ratio of UV curable functional groups to moisture curable functional groups between 1:0.9 and 1:0.1. In other embodiments, the ratio of moisture curable functionality to UV cure functionality may be selected from the group consisting of: 1:0.9, 1:0.8, 1:0.7, 1:0.6, 1:0.5, 1:0.4, 1:0.3, 1:0.2 and 1:0.1.

In one embodiment, the hydroxyl terminated acrylate is a C₂-C₁₂ alkylacrylate or alkylmethacrylate. The hydroxyl terminated acrylates can be made from the reaction of an acrylic acid or methacrylic acid with a diol, triol, or polyol, to form an ester containing at least one free hydroxyl group. Suitable diol, triol, and polyols include, but are not limited to of 2,2-dialkyl-1,3-propanediols, 2-acyl-2-hydroxyalkyl-1,3-propanediols and 2,2-dihydroxy-alkyl-1,3-propanediols. Suitable diols, triols and polyols can be exemplified by 1,4-butanediol, neopentyl glycol, 2-butyl-2-ethyl-1,3-propanediol, diethylene glycol, 1,6-hexanediol, triethylene glycol, 1,3-dimethanol-cyclohexane, 1,4-dimethanol-cyclohexane, ethylene glycol, 1,3-dimethanolbenzene, 1,4-dimethanolbenzene, bis-hydroxyethyl bisphenol A, dimethanoltricyclodecane, trimethylolethane, trimethylolpropane, pentaerythritol, ditrimethylolethane, ditrimethylolpropane, dipentaerythritol, anhydroenneaheptitol, 1,4-butanediol-2, bis-hydroxyethyl-hydroquinone bisphenol A, bisphenol F and/or a dendritic polyester and/or polyether polyol.

In one embodiment, suitable hydroxyl terminated acrylates include hydroxyethyl (meth)acrylate, 0.10 hydroxypropyl(meth)acrylate, hydroxybutyl (meth)acrylate, trimethylolpropane di(meth)acrylate, alkylene oxide modified glycerol di(meth)acrylate, alkylene oxide modified trimethylolpropane di(meth)acrylate, alkylene oxide modified pentaerythritol di or tri(meth)acrylate, ditrimethylolpropane di or tri(meth)acrylate and/or dipentaerythritol penta(meth)acrylate. Said alkylene oxide is preferably ethylene oxide and/or propylene oxide.

In one embodiment, the hydroxyl terminated acrylate is represented by a compound of formula 2:

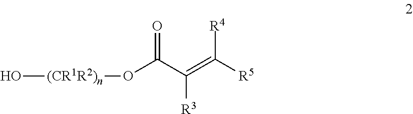

wherein, n is an integer selected from 2 to 12; R¹ and R² in each instance is independently selected from the group consisting of hydrogen, alkyl, cycloakyl, alkenyl, alkynyl, heterocyclcoalkyl, aryl, and heteroaryl; or R1 and R2 taken together can form a 3-7 membered carbocylic, ring; R³, R⁴, and R⁵, in each instance is independently selected from the group consisting of hydrogen, alkyl, cycloakyl, alkenyl, alkynyl, heterocyclcoakyl, aryl, and heteroaryl; or R³ and R⁴ taken together form a 5 to 6 membered carbocylic ring; or R⁴ and R⁵ taken together form a 5 to 6 membered carbocylic ring.

In a more specific embodiment, the hydroxyl terminated acrylate is hydroxyethylmethacrylate (HEMA).

In some embodiments, the hydroxyl terminated acrylate is represented by the formula 3:

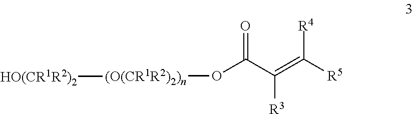

wherein, n is an integer selected from 1 to 20; R¹ and R² in each instance is independently selected from the group consisting of hydrogen, alkyl, cycloakyl, alkenyl, alkynyl, heterocyclcoakyl, aryl, and heteroaryl; or R1 and R2 taken together can form a 3-7 membered carbocylic ring; R³, R⁴, and R⁵, in each instance is independently selected from the group consisting of hydrogen, alkyl, cycloakyl, alkenyl, alkynyl, heterocyclcoakyl, aryl, and heteroaryl; or R³ and R⁴ taken together form a 5 to 6 membered carbocylic ring; or R⁴ and R⁵ taken together form a 5 to 6 membered carbocylic ring.

The reaction between an isocyanate terminated dendritic polymer, e.g., the reaction product of Scheme I, and a hydroxyl substituted acrylic compound may be exemplified by Scheme II below.

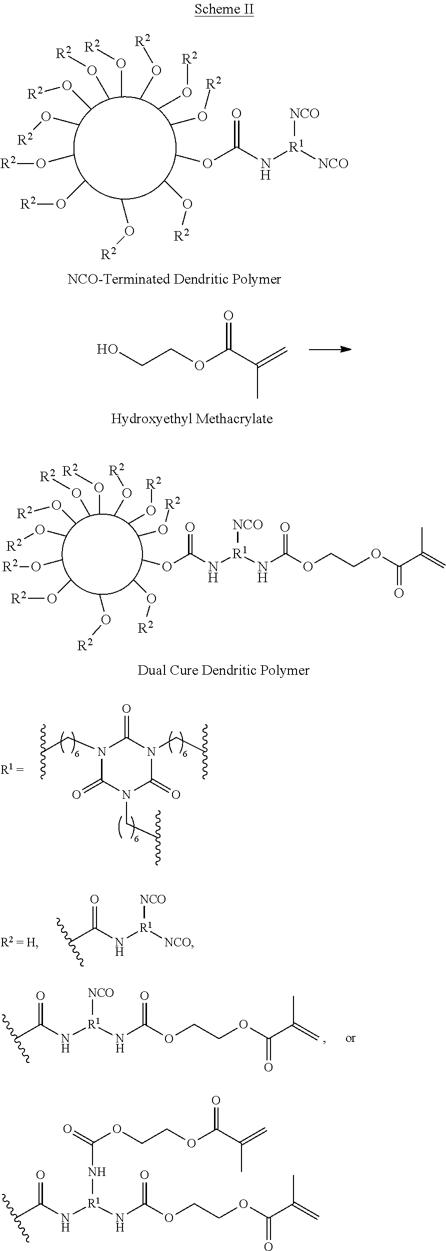

As can be seen from Scheme II, the hydroxyl group of the acrylic ester forms a carbamate bond with an isocyanate group on the dendritic polymer to form a product dendritic polymer having at least one unreacted isocyanate group and an acrylate functional group. The amount of acrylic ester may be suitably controlled to ensure that at least some of the isocyanate groups remain unreacted. Advantageously, having unreacted isocyanate groups in the final product is useful for facilitating moisture-curing, even in the absence of a radiation source.

In instances where the cross-linker, e.g. HDI trimer, is reacted in stoichiometric excess to each peripheral hydroxyl functional group on the dendritic polymer, R² may not be H.

In this embodiment, during the reaction step (b), the stoichiometry of acrylate to isocyanate groups on the starting material may be suitably adjusted in order to form a product dendritic polymer having any ratio of isocyanate and acrylate functional groups. In one embodiment, the ratio of isocyanate to acrylate functionality is from about 0.01:1 to about 1:0.01; from about 1:0.9 to about 1:0.1; from about 1:10 to about 10:1; or from about 7:1 to about 1:0.5. In certain embodiments, the isocyanate to acrylate ratio is between about 0.01:1 to about 0.05:1.

A catalyst may also be added to the reaction of the cross-linker with the dendritic polymer, reaction of the reaction product of the cross-linker and the dendritic polymer and the acrylate, or both to catalyze the reaction. Suitable catalysts include Lewis acids, such as stannous octoate (tin(II) ethylhexanoate), dibutyltin dilaureate (DBTDL).

The disclosed method may further comprise a step of mixing the substituted dendritic polymer composition obtained in Scheme II with any one or more of the following additives to form the dual-curable dendritic polymer composition: (i) silane based curing agent; (ii) photoinitiator; or (iii) a polyol.

In one embodiment, the silane-based curing agent may comprise methacryloxy and methoxy silane functionality. Advantageously, the methacryloxy may assist during a subsequent curing step by co-polymerization with vinyl acrylate groups to yield a moisture-curable silylated polymer. Also advantageously, the methoxy silane functionality may allow the polymer composition to bond to inorganic substrates to improve the adhesive properties of the polymer composition. Notably, such silane-based curing agents will be useful for coating applications. In one embodiment, the silane-based curing agent is gamma-methaacryloxypropyltrimethoxy silane. An exemplary gamma-methaacryloxypropyltrimethoxy silane is one marketed by Momentive Performance Materials, under the Trademark Silquest. In another embodiment, the silane based-curing agent is a polyether-modified polydimethylsiloxane. The silane-based curing agent may also act as an adhesion promoter.

The photoinitiator is typically a compound that upon interaction with photons forms reactive intermediates capable of initiating radical reactions. Exemplary photoinitiators include but are not limited to compounds such as, benzophenone, cyclohexyl phenyl or mixtures thereof. In one embodiment, the photoinitiator is an equal part mixture of 1-hydroxy-cyclohexyl-phenyl ketone and benzophenone. An exemplary photoinitiator may be one marketed by Ciba Specialty Chemicals Inc., under the trademark IRGACURE®.

One or more polyols may be mixed with the dendritic polymer obtained from step (b) to form a coating composition. The polyol may act as a curing agent during instances where ambient moisture may be insufficient to cause curing. Suitable polyols are known to the person skilled in the art and may comprise polyethylene glycol (PEG), polypropylene glycol (PPG), poly(tetremethylene ether)glycol, polyester polyols, polyacrylate polyols, and mixtures thereof.

One or more solvents may be mixed with the dendritic polymer obtained from step (b) to form a coating composition. Suitable solvents may include solvents containing at least one hydroxyl functional group. An exemplary solvent containing at least one hydroxyl function group is sold under the Texanol trademark by Eastman, e.g., 2,2,4-trimethyl-1,3-pentanediol monoisobutyrate.

Exemplary, non-limiting embodiments of a dual curable dendritic polymer will now be disclosed.

In one embodiment, there is provided a dendritic polymer having a mixture of peripheral functional groups selected from UV curable functional groups and moisture curable functional groups, wherein said dendritic polymer comprises at least a total of 8 to 128 functional groups per polymer molecule. In one embodiment, the moisture curable functional groups comprise at least one peripheral moisture curable functional group. In one embodiment, the UV curable functional groups are acrylate functional groups. In yet another embodiment, the moisture curable functional groups are isocyanate groups.

In one embodiment, the dendritic polymer has formula 1:

D(OR)ₓ 1

wherein
X is an integer selected from 8-128; D is selected from a 1-4 generation dendritic polymer; R independently in each instance is hydrogen,

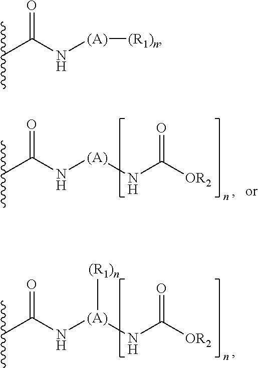

wherein n in each instance is independently an integer selected from 1-10; A is a crosslinker; R₁ is a moisture curable group; R₂ is a UV curable group or -D(OR)_{X-1}; wherein the compound of formula 1 has at least one moisture curable group and at least one UV curable group, and wherein at least one moisture curable functional group is a peripheral moisture curable functional group.

In certain embodiments, the dendritic polymer has formula 1 and D is a hyperbranched polymer. In certain embodiments, the hyperbranched polymer is a polyester polyol.

Certain embodiments relate to any of the aforementioned embodiments, wherein the hyperbranched polymer is generation 1, 1.5, 2, 2.5, or 3.

One embodiment, relates any of the aforementioned embodiments, wherein X is 16, 32, or 64.

Certain embodiments relate to any of the aforementioned embodiments, wherein the crosslinker is derived from a diisocyanate, a triisocyanate, a polyisocyanate; or dimers, biuret dimers, or isocyanurate trimers thereof; wherein at least one isocyanate of the crosslinker is covalently attached to a hydroxyl group on the dendritic polymer to form a carbamate.

Certain embodiments relate to any of the aforementioned embodiments, wherein the crosslinker is

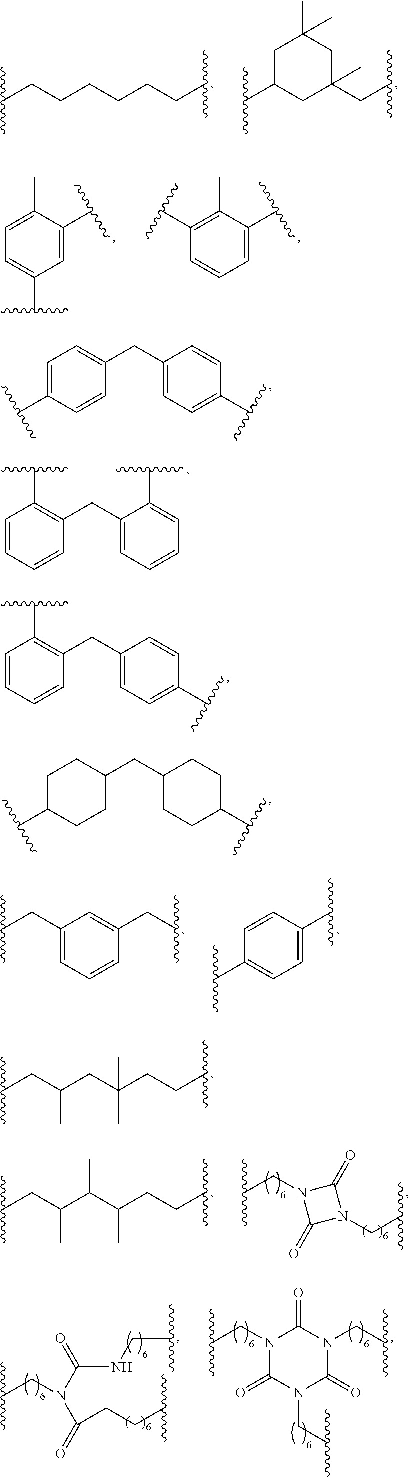

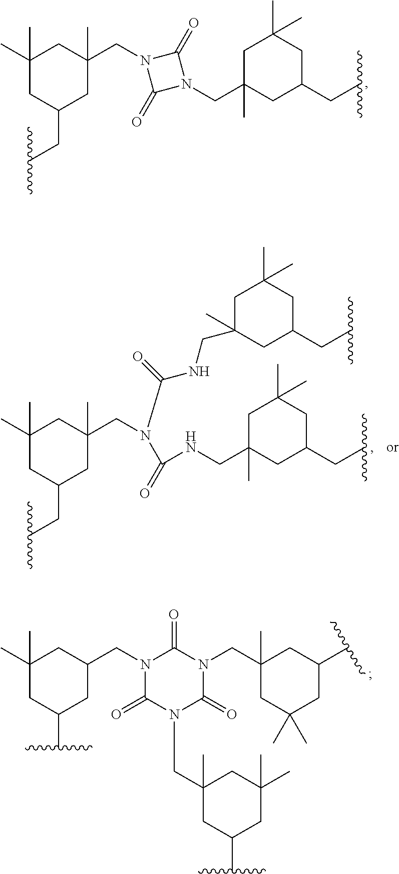 [SMILES: *CC1CC(C)(C)CC(C)(CN2C(=O)N(CC3(C)CC(C*)CC(C)(C)C3)C2=O)C1 ; *CC1CC(C)(C)CC(C)(CNC(=O)N(CC2(C)CC(C*)CC(C)(C)C2)C(=O)NCC2(C)CC(C*)CC(C)(C)C2)C1 ; *C1CC(Cn2c(=O)n(CC3(C)CC(*)CC(C)(C)C3)c(=O)n(CC3(C)CC(*)CC(C)(C)C3)c2=O)CC(C)(C)C1]

and mixtures thereof.

Certain embodiments relate to any of the aforementioned embodiments, wherein the UV curable group comprises an acrylate, a methacrylate, or a styrene.

Certain embodiments relate to any of the aforementioned embodiments, wherein the UV curable group is:

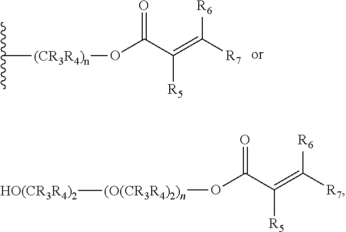

wherein
n is an integer selected from 2-10; R₃ and R₄ independently in each instance is hydrogen alkyl, alkenyl, alkynyl, cycloalkyl, heterocycloalkyl, aryl, or heteroaryl; or R₃ and R₄ taken together with the carbon atoms to which they are attached form a 3-7 membered carbocycle; and R₅, R₆, and R₇ independently in each instance is hydrogen alkyl, alkenyl, alkynyl, cycloalkyl, heterocycloalkyl, aryl, or heteroaryl; or R₅ and R₇ taken together with the carbon atoms to which they are attached form a 3-7 membered carbocycle; or R₆ and R₇ taken together with the carbon atoms to which they are attached form a 3-7 membered carbocycle.

Certain embodiments relate to any of the aforementioned embodiments, wherein the UV curable group is

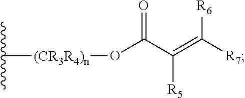

and R₅ is hydrogen or methyl, R₆ is hydrogen, and R₇ is hydrogen.

Certain embodiments relate to any of the aforementioned embodiments, wherein the UV curable group is covalently attached to the crosslinker by the reaction of an alcohol attached to the UV curable group and at least one isocyanate on the crosslinker to form a carbamate group.

Certain embodiments relate to any of the aforementioned embodiments, wherein the moisture curable group is an isocyanate, a blocked isocyanate, a mono-oxazolidine, or a bis-oxazolidine.

Certain embodiments relate to any of the aforementioned embodiments, wherein the moisture curable group is an isocyanate and at least one isocyanate on the crosslinker is the moisture curable group.

Certain embodiments relate to any of the aforementioned embodiments, wherein in each instance R is independently selected from the group consisting of

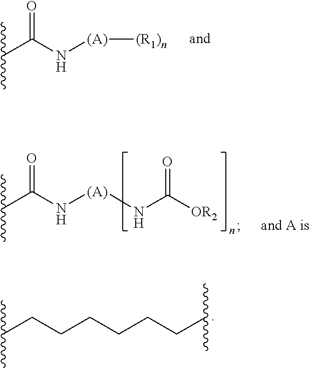

Certain embodiments relate to any of the aforementioned embodiments, wherein in each instance R is independently selected from the group consisting of

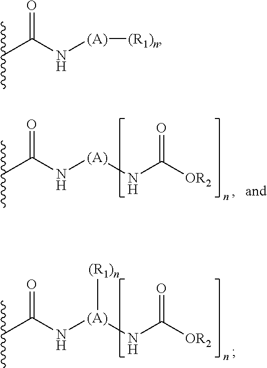

and in each instance A is independently selected from the group consisting of

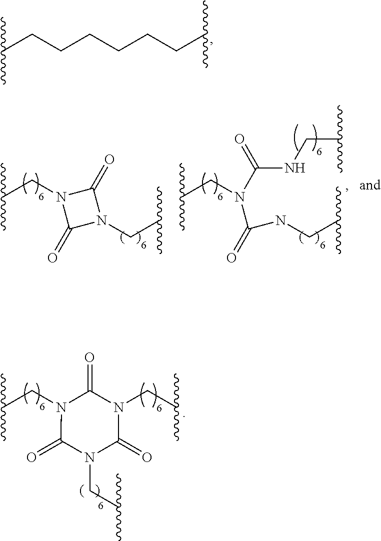

Certain embodiments relate to any of the aforementioned embodiments, wherein D is a hyperbranched polyester polyol and X is equal to 16, 32, or 64.

Certain embodiments relate to a polymer composition comprising any of the aforementioned embodiments and one or more of the following:

(a) a catalyst;

(b) a silane-based curing compound;

(c) a polyol;

(d) a sterically hindered amine light stabilizer;

(e) a UV absorber;

(f) a photoinitiator; and

(g) a solvent comprising at least one hydroxyl functional group.

In certain embodiments, the solvent comprising at least one hydroxyl functional group is sold under the Texanol trademark by Eastman, e.g., 2,2,4-trimethyl-1,3-pentanediol monoisobutyrate.

In one embodiment, the ratio of moisture curable functional groups to UV curable functional groups on the attached to the dendritic polymer may be between 1:0.9 and 1:0.1. In other embodiments, the ratio of moisture cure functionality to UV cure functionality may be selected from the group consisting of: about 0.01:1, about 0.05:1, about 1:0.9, about 1:0.8, about 1:0.7, about 1:0.6, about 1:0.5, about 1:0.4, about 1:0.3, about 1:0.2 and about 1:0.1.

In another embodiment, the present disclosure provides a polymer composition comprising: (a) a dendritic polymer having at least 16 to 128 peripheral functional groups selected from the group consisting of: —R¹—NCO, —R¹—NHCO—O—(CH₂)ₙ—R², wherein n is an integer from 1 to 10, R¹ is as defined above and R² is an acrylate, or a C₁₋₁₀ substituted alkyl acrylate, or has the formula 4:

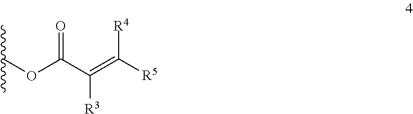

wherein, R³, R⁴, and R⁵, in each instance is independently selected from the group consisting of hydrogen, alkyl, cycloakyl, alkenyl, alkynyl, heterocyclcoakyl, aryl, and heteroaryl; or R³ and R⁴ taken together form a 5 to 6 membered carbocylic ring; or R⁴ and R⁵ taken together form a 5 to 6 carbocylic membered ring. In certain embodiments, R³ is acrylate or methacrylate. The integer n may be selected from 1, 2, 3, 4, 5, 6, 7, 8, 9 or 10 and may depend on the type acrylate compound used to introduce the acrylate functional groups onto the dendritic polymer composition. For instance, if hydroxyethylacrylate (HEA) was used for reaction with the —NCO terminated dendritic polymer in the above discussed method, then n will be 2. The R¹—NCO functional groups and

R¹—NHCO—O—(CH₂)ₙ—R² functional groups may be provided in a number ratio of from 1:0.9 to 1:0.1. In one embodiment, the number ratio of R¹—NCO functional groups to R¹—NHCO—O—(CH₂)ₙ—R² functional groups is 7:1.

The polymer composition may further comprise any one or more of the following additives: a catalyst; a silane-based curing compound; a polyol; and a photoinitiator. The exemplary additives are as discussed above.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1a shows a Fourier Transform Infra Red (FTIR) spectra of a dual-curable dendritic polymer composition prior to reaction with a hydroxyacrylate.

FIG. 1b shows a FTIR spectrum of a dual-curable dendritic polymer composition after reaction with a hydroxyacrylate.

### DETAILED DESCRIPTION OF DRAWINGS

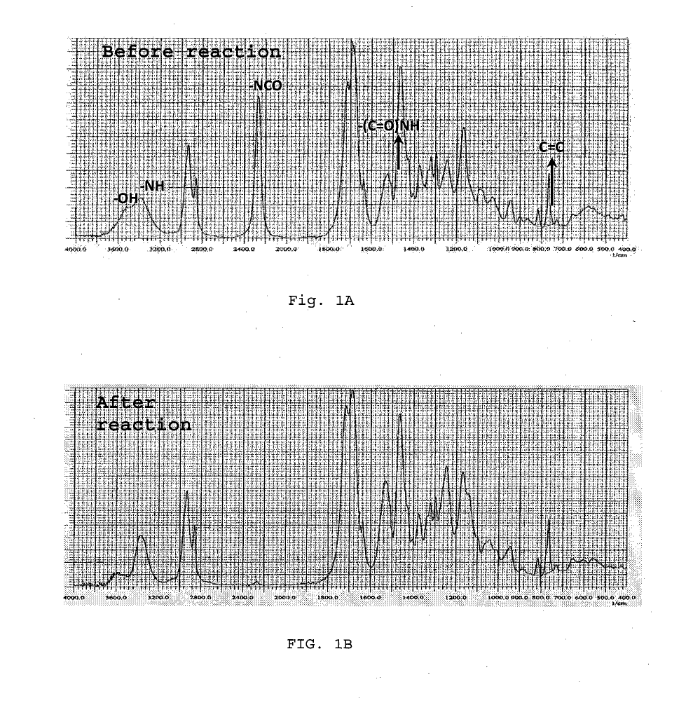

Referring to FIG. 1, there is shown the FTIR spectra of an unsaturated dendritic polymer before (FIG. 1a) and after (FIG. 1b) reaction were obtained. In particular, it can be seen that after reaction with the hydroxyl acrylate, the intensity of —OH band and —NCO band significantly decreases, while that of —NH and —(C═O)NH band increases. These characterization results confirm the reaction between the isocyanate and hydroxyethyl methacrylate. To compare the amount of C═C before and after reaction, the band at 810 cm⁻¹ was selected as the characteristic band and the band at 765 cm⁻¹ as the internal band.

The absorbance ratio between characteristic band and internal band (A810 cm⁻¹/A765 cm⁻¹) was calculated to be 0.32 for both before and after reaction, indicating that no consumption of acrylate double bond occurred during this reaction.

### EXAMPLES

Non-limiting examples of the invention will be further described in greater detail by reference to specific Examples, which should not be construed as in any way limiting the scope of the invention.

### List of Raw Materials Used in the Examples

1. Boltorn H40s™: A dendritic polymer with theoretically 64 peripheral hydroxyl functional groups, having a molecular weight of about 5100 g/mol. It is a 50% solid in an organic solvent.
2. Desmodur N3600™: A hexamethylene diisocyanate (HDI), with NCO content about 23%, procured from Bayer MaterialScience AG.
3. Bayhydur XP 2547: A water-dispersible, hexamethylene diisocyanate (HDI), with NCO equivalent weight about 182 procured from Bayer MaterialScience AG.
4. Irgacure® 500™: A photoinitiator comprising cyclohexylphenyl ketone and benzophenone, procured from Ciba Specialty Chemicals, Inc.
5. BYK302: A polyether modified polydimethyl siloxsane surfactant, procured from BYK Chemie.

### Example 1

### Preparation of NCO-Terminated Dendritic Polymer (BBH40S-SUH)

90 g of Boltorn H40s and 400 g of butyl acetate were charged in a 4-necked reaction flask equipped with stirrer, nitrogen inlet and condenser. The temperature was raised from room temperature to 90° C. within 30 minutes.

2.4 g of dibutyltin dilaurate (10% by weight in butyl acetate) was added and followed by 500 g Desmodur N3600. An exothermic reaction proceeded and the reaction temperature is maintained at between 89 to 91° C. for 20 min.

### Example 2

162.3 g of the NCO— terminated dendritic polyurethane pre-polymer of Example 1 (BBH40S-SUH) was subsequently charged in a 4-necked reaction flask equipped with stirrer, nitrogen inlet and condenser. The temperature of the flask was raised from room temperature to 50° C. within 30 minutes.

0.2 g of dibutyltin dilaurate (10% by weight in butyl acetate) was added into the reaction mixture, followed by 37.5 g hydroxyethyl methacrylate. An exothermic reaction proceeded and the reaction temperature is maintained between 49. to 51° C. for one hour.

### Example 3

168.6 g of the NCO— terminated dendritic prepolymer of Example 1 (BBH40S-SUH) was charged in a 4-necked reaction flask equipped with stirrer, nitrogen inlet and condenser. The temperature was raised from room temperature to 50° C. within 30 minutes.

0.2 g of dibutyltin dilaurate (10% by weight in butyl acetate) was added and this is followed by the addition of 31.2 g of hydroxyethyl methacrylate (HEMA). Exothermic reaction ensued and the reaction temperature was maintained between 49 to 51° C. for one hour.

### Example 4

179.1 g of the NCO— terminated dendritic polyurethane prepolymer of Example 1 (BBH40S-SUH) was charged in a 4-necked reaction flask equipped with stirrer, nitrogen inlet and condenser. The, temperature was raised from room temperature to 50° C. within 30 minutes.

0.2 g of dibutyltin dilaurate (10% by weight in butyl acetate) was added and this was followed by the addition of 20.7 g hydroxyethyl methacrylate. An exothermic reaction ensued and the reaction temperature was maintained between 49 to 51° C. for one hour.

A summary of reaction results of Examples 1 to 4 is provided in Table 1 below.

TABLE 1

| | Example 1 | Example 2 | Example 3 | Example 4 |
|---|---|---|---|---|
| NCO:OH | 7:1 | 1:1 | 1:0.8 | 1:0.5 |
| ratio | | | | |
| Nonvolatile | 51.5 | 68.2 | 66.2 | 64.2 |
| content | | | | |
| (wt %) | | | | |
| Free NCO | 7.39 | 1.6 | 1.8 | 4.1 |
| content, | | | | |
| (wt %): | | | | |
| Viscosity | 50 | 660 | 750 | 610 |
| at 25° C., | | | | |
| (cps) | | | | |

### Example 5

Preparation of Water Dispersible NCO-Terminated Dendritic Polymer (BBWUH)

90 g of Boltorn H40s and 400 g of butyl acetate were charged in a 4-necked reaction flask equipped with stirrer, nitrogen inlet and condenser. The temperature was raised from room temperature to 90° C. within 30 minutes.

2.4 g of dibutyltin dilaurate (10% by weight in butyl acetate) was added and this is followed by the addition of 500 g Bayhydur XP2547. Exothermic reaction ensued and the reaction temperature was maintained between 89 to 91° C. for 20 min.

### Example 6

156.8 g of the NCO— terminated dendritic polyurethane prepolymer of Example 5 (BBH40S-WUH) was charged in a 4-necked reaction flask equipped with stirrer, nitrogen inlet and condenser. The temperature was raised from room temperature to 50° C. within 30 minutes.

0.2 g of dibutyltin dilaurate (10% by weight, in butyl acetate) was added and this was followed by the addition of 43.0 g hydroxyethyl methacrylate. Exothermic reaction ensued and the reaction temperature was maintained between 49 to 51° C. for one hour.

### Example 7

163.9 g of the NCO— terminated dendritic polyurethane prepolymer of Example 5 (BBH40S-WUH) was charged in a 4-necked reaction flask equipped with stirrer, nitrogen inlet and condenser. The temperature was raised from room temperature to 50° C. within 30 minutes.

0.2 g of dibutyltin dilaurate (10% by weight in butyl acetate) was added and this, is followed by the addition of 35.9 g hydroxyethyl methacrylate. Exothermic reaction ensued and the reaction temperature was maintained between 49 to 51° C. for one hour.

### Example 8

178.0 g of the NCO— terminated dendritic polyurethane prepolymer of Example 5 (BBH40S-WUH) was charged in a 4-necked reaction flask equipped with stirrer, nitrogen inlet and condenser. The temperature was raised from room temperature to 50° C. within 30 minutes.

0.2 g of dibutyltin dilaurate (10% by weight in butyl acetate) was added and this was followed by the addition of 21.8 g hydroxyethyl methacrylate. Exothermic reaction ensued and the reaction temperature was maintained between 49 to 51° C. for one hour.

A summary of results of Examples 5 to 8 is provided in Table 2 below.

TABLE 2

| | Example 5 | Example 6 | Example 7 | Example 8 |
|---|---|---|---|---|
| NCO:OH | 7:1 | 1.15:1 | 1:0.9 | 1:0.5 |
| ratio | | | | |
| Nonvolatile | 52.1 | 67.1 | 67.0 | 61.4 |
| content | | | | |
| (wt %) | | | | |
| Free NCO | 7.82 | 0 | 0.6 | 3.7 |
| content, | | | | |
| (wt %): | | | | |
| Viscosity | 50 | 536 | 882 | 364 |
| at 25° C., | | | | |
| (cps) | | | | |

### Example 9

Six different formulations of an ultraviolet (UV) curable lacquer were prepared based on the unsaturated dendritic polyurethane (UDP) obtained from Examples 2, 3, 4, 6, 7 & 8. Their respective compositions are shown in Table 3.

TABLE 3

| | Ex. 2 | Ex. 3 | Ex. 4 | Ex. 6 | Ex. 7 | Ex. 8 |
|---|---|---|---|---|---|---|
| UDP resin (g) | 26.66 | 27.46 | 28.32 | 27.09 | 27.13 | 29.61 |
| Silquest | 1.00 | 1.00 | 1.00 | 1.00 | 1.00 | 1.00 |
| A174NT (g) | | | | | | |
| BYK302 (g) | 0.22 | 0.22 | 0.22 | 0.22 | 0.22 | 0.22 |
| Irgacure 500 | 0.60 | 0.60 | 0.60 | 0.60 | 0.60 | 0.60 |
| (g) | | | | | | |

The weight of each of the formulation was adjusted to contain substantially the same solid amount (i.e., 18.18 g) of the UDP resin.

### Comparative Example 10

A comparative UV curable lacquer was prepared based on a competitive hyperbranched polyester acrylate oligomer “A”. The composition of the comparative lacquer is shown below in Table 4.

TABLE 4

| Component | Weight in grams |
|---|---|
| Resin A | 18.18 |
| Silquest | 1.00 |
| A174NT | |
| BYK302 | 0.22 |
| Irgacure 500 | 0.60 |
| Butyl Acetate | 9.50 |

The prepared lacquer containing butyl acetate solvent was coated on 220 mesh sanded tin panels at a film thickness of 100μ (wet). Performance tests, including pencil hardness, impact resistant and adhesion, were carried out at 25±2° C. and 70±5% relative humidity. The following standard test methods were employed.

### Pencil Hardness—ASTM D3363-00

### Impact Resistance—G14-88

### Adhesion Test—ASTM D3359-02

### Results and Discussion

The polymer formulations prepared from Sample 4 and Sample 8 in Example 9 were used for comparison. Both samples have free isocyanate and acrylate functional groups and are dual curable polymer systems.

The test results in Table 5 shows even without the presence of UV radiation, the polymer compositions can cure at room temperature.

TABLE 5
7 days Room Temperature

| Sample | 4 | 8 |
|---|---|---|
| Pencil | HB | 3B |
| Hardness | | |
| (Mark) | | |
| Impact Resistance | >160 | >160 |
| (in/lb) | | |
| Cross cut Adhesion | 0 | 0 |
| (% area peel) | | |

The comparative test results shown in Table 6 demonstrates the dual-curable dendritic polymers prepared according to the present invention exhibit improved pencil hardness, impact resistance and adhesion when compared to the competitive hyperbranched polyester acrylate made from Comparative Example 10.

TABLE 6
3 days room temperature curing followed by 450
second UV irradiation

| | | | | | | | 450 second |
|---|---|---|---|---|---|---|---|
| | | | | | | | UV |
| | Sample | | | | | | Irradiation |
| | 2 | 3 | 4 | 6 | 7 | 8 | A |
| Pencil | 3H | 4H | 4H | 3H | 3H | 4H | H |
| Hardness | | | | | | | |
| (Mark) | | | | | | | |
| Impact | 15 | 22 | 34 | 9 | 14 | 24 | 8 |
| Resistance | | | | | | | |
| (in/lb) | | | | | | | |
| Cross cut | 70 | 60 | 15 | 70 | 80 | 70 | 100 |
| Adhesion | | | | | | | |
| (% area | | | | | | | |
| peel) | | | | | | | |

### Applications

The disclosed method for preparing a dual curable dendritic polymer composition sees utility in at least the following areas: wood coatings, floor coatings, industrial OEM coatings and plastic coatings.

The dual curable polymer compositions prepared from the disclosed method overcome conventional drawbacks of UV-curable compositions, due to its ability to moisture-cure under room temperature conditions and in the absence of an external radiation source. This affords improved flexibility and overall reduces energy cost. This also avoids problems associated with uneven curing due to the non-uniform exposure to UV radiation encountered by methods in the art.

Additionally, the disclosed dual-curable, polymer compositions may be water-dispersible by selecting suitable hydrophilic polyisocyanates as the cross-linkers. As a result, the use of organic solvents is negated which allow the disclosed compositions to substantially reduce or avoid VOC emissions entirely.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of preparing a dual curable polymer, the method comprising the steps of:
(a) reacting a peripheral reactive group of a dendritic polymer with a cross-linker compound having two or more isocyanate functional groups to form a functionalized dendritic polymer terminated with said isocyanate functional groups; and
(b) reacting said functionalized dendritic polymer with an acrylate compound to form a substituted dendritic polymer having a mixture of acrylate functional groups and at least one peripheral isocyanate functional group.

2. The method of claim 1, wherein said reactive groups of said dendritic polymer are selected from the group consisting of: hydroxyl, amine, carboxyl, carbamate and halogen.

3. The method of claim 2, wherein said cross-linker compound is selected to comprise isocyanate functional groups capable of forming covalent bonds with said acrylate compound, wherein said isocyanate functional groups are selected from the group consisting of: isocyanates, blocked isocyanates, and combinations thereof.

4. (canceled)

5. The method of claim 3, wherein said cross-linker compound is selected from the group of diisocyanates, tri-isocyanates, dimers of said polyisocyanates, biuret dimers of said polyisocyanates, isocyanurate trimers of said polyisocyanates, toluene diisocyanate (TDI), methylene diphenyl diisocyanate (MDI), 4′4-dicyclohexamethylene diisocyanate (H₁₂MDI), xylene diisocyanate, p-phenyl diisocyanate (PPDI), hexamethylene diisocyanate (HDI), isophorone diisocyanate (IPDI), trimethyl hexamethylene diisocyanate (TMDI), isocyanurate trimers of HDT, dimers of HDI, biuret dimers of HDI, dimers of IPDI, biuret dimers of IPDI, isocyanurate trimers of IPDI, and mixtures thereof.

6. (canceled)

7. The method of claim 5, wherein the polyisocyanate is a hydrophilic polyisocyanate.

8. The method of claim 1, wherein said cross-linker compound is reacted in stoichiometric excess with the peripheral reactive group of the dendritic polymer.

9. The method of claim 1, wherein said acrylate compound comprises at least one terminal moiety capable of reacting with said isocyanate functional group, wherein said terminal moiety is selected from the group consisting of: —OH and —NHR, wherein R is selected from hydrogen, alkyl, alkenyl, alkynyl, aralykyl, cycloalkyl, heterocycloalkyl, and aryl.

10. (canceled)

11. The method of claim 9, wherein said acrylate compound is a C₂-C₁₂ alkylacrylate or alkylmethacrylate.

12. (canceled)

13. The method of claim 11, wherein said hydroxyl terminated acrylate is hydroxyethylmethacrylate (HEMA).

14. The method of claim 1, wherein the stoichiometric amount of the acrylate compound is controlled to be less than the stoichiometric amount of the cross-linker compound.

15. The method of claim 1, wherein the dendritic polymer is selected to comprise 16, 32, 64 or 128 peripheral hydroxyl groups per dendritic polymer.

16. The method of claim 1, wherein the method further comprises a step of mixing the substituted dendritic polymer composition with one or more of the following additives:
(i) silane based curing agent;
(ii) photoinitiator;
(iii) catalyst;
(iv) a polyol; and
(V) a solvent comprising at least one hydroxyl functional group.

17. A dendritic polymer having a mixture of peripheral functional groups selected from UV curable functional groups and moisture curable functional groups, wherein said dendritic polymer comprises at least a total of 8 to 128 peripheral functional groups per polymer molecule, and wherein the peripheral functional groups comprise at least one isocyanate functional group.

18. The dendritic polymer of claim 17, wherein said UV curable functional groups are acrylate groups and all of said peripheral moisture curable functional groups are isocyanate groups.

19. (canceled)

20. The dendritic polymer of claim 17, wherein said moisture curable functional groups and UV curable functional groups are in a number ratio of from 0.01:1 to 1:0.01.

21. (canceled)

22. The dendritic polymer of claim 17, having formula 1:
D(OR)ₓ 1
wherein
X is an integer selected from 8-128;
D is selected from a 1-4 generation dendritic polymer;
R independently in each instance is hydrogen, 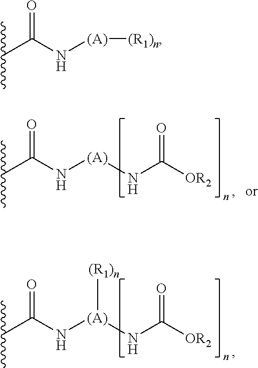
wherein
n in each instance is independently an integer selected from 1-10;
A is a crosslinker;
R₁ is an isocyanate group;
R₂ is a UV curable group or -D(OR)_{X-1}; and
wherein the compound of formula 1 has at least one moisture curable group and at least one UV curable group, and wherein at least one moisture curable functional group is a peripheral isocyanate functional group.

23. The dendritic polymer of claim 22, wherein D is a hyperbranched polyester polyol of generation 1, 1.5, 5, 2.5, or 3 polymer.

24. (canceled)

25. (canceled)

26. The dendritic polymer of claim 22, wherein X is 16, 32, or 64.

27. The dendritic polymer of claim 22, wherein the crosslinker is derived from a diisocyanate, a triisocyanate, a polyisocyanate; or dimers, biuret dimers, or isocyanurate trimers thereof; wherein at least one isocyanate of the crosslinker is covalently attached to a hydroxyl group on the dendritic polymer to form a carbamate.

28. The dendritic polymer of claim 22, wherein the crosslinker is 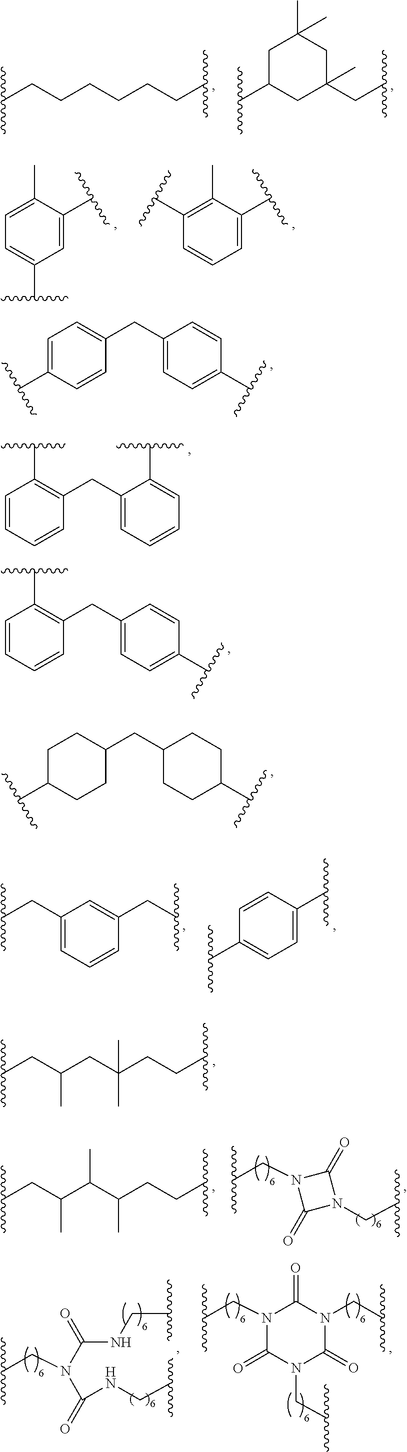 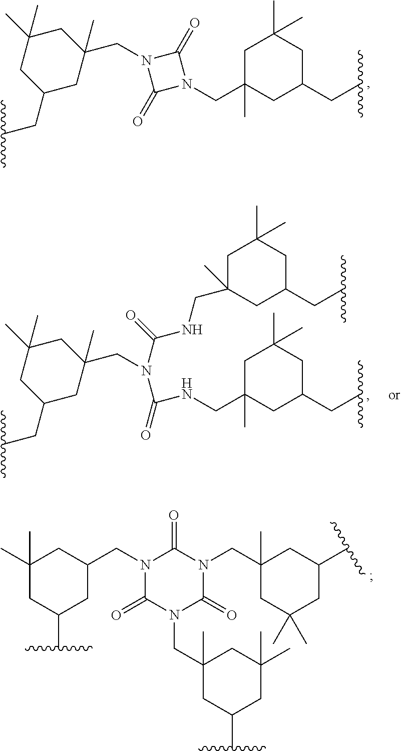 [SMILES: *CC1CC(C)(C)CC(C)(CN2C(=O)N(CC3(C)CC(C*)CC(C)(C)C3)C2=O)C1 ; *CC1CC(C)(C)CC(C)(CNC(=O)N(CC2(C)CC(C*)CC(C)(C)C2)C(=O)NCC2(C)CC(C*)CC(C)(C)C2)C1 ; *C1CC(Cn2c(=O)n(CC3(C)CC(*)CC(C)(C)C3)c(=O)n(CC3(C)CC(*)CC(C)(C)C3)c2=O)CC(C)(C)C1]
and mixtures thereof.

29. The dendritic polymer of claim 22, wherein the UV curable group is selected from the group consisting of an acrylate, a methacrylate, a styrene. 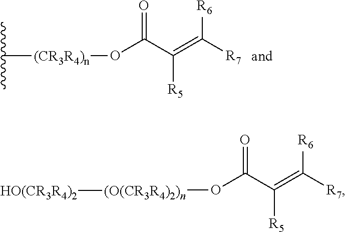
wherein
n is an integer selected from 2-10;
R3 and R4 independently in each instance is hydrogen alkyl, alkenyl, alkynyl, cycloalkyl, heterocycloalkyl, aryl, or heteroaryl; or R₃ and R₄ taken together with the carbon atoms to which they are attached form a 3-7 membered carbocycle; and
R5, R6, and R₇ independently in each instance is hydrogen alkyl, alkenyl, alkynyl, cycloalkyl, heterocycloalkyl, aryl, or heteroaryl; or R₅ and R₇ taken together with the carbon atoms to which they are attached form a 3-7 membered carbocycle; or R₆ and R₇ taken together with the carbon atoms to which they are attached form a 3-7 membered carbocycle.

30. (canceled)

31. The dendritic polymer of claim 29, wherein the UV curable group is 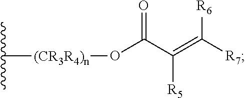
and R₅ is hydrogen or methyl, R6 is hydrogen, and R₇ is hydrogen.

32. (canceled)

33. The dendritic polymer of claim 22, wherein the moisture curable group is an isocyanate, or a blocked isocyanate.

34. (canceled)

35. The dendritic polymer of claim 22, wherein in each instance, R is independently selected from the group consisting of

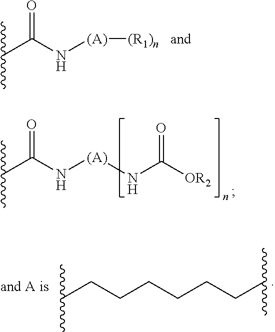

36. The dendritic polymer of claim 22, wherein in each instance, R is independently selected from the group consisting of 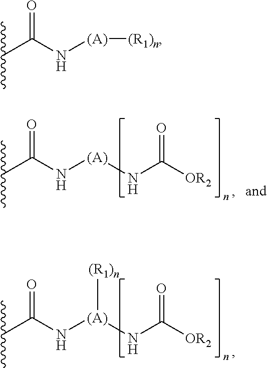
and in each instance, A is independently selected from the group consisting of

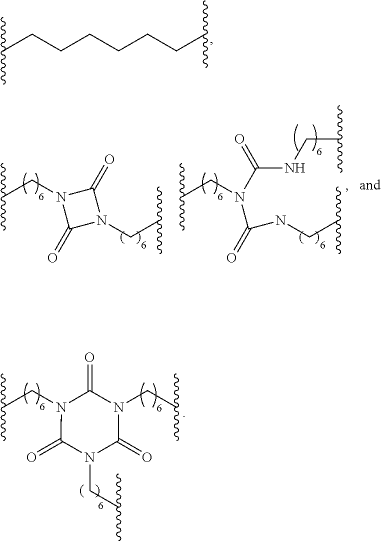

37. (canceled)

38. A polymer composition comprising the dendritic polymer of claim 17 and one or more of the following:
(a) a catalyst;
(b) a silane-based curing compound;
(c) a polyol;
(d) a sterically hindered amine light stabilizer;
(e) a UV absorber;
(f) a photoinitiator; and
(g) a solvent comprising at least one hydroxyl functional group.

39. The polymer composition of claim 38, wherein the polymer composition is a 1K composition.
